(19) United States
(12) Patent Application Publication
(10) Pub. No.: US 2003/0079066 A1
(43) Pub. Date: Apr. 24, 2003

(54) Method and system to select from among a plurality of devices to host a large-capacity storage interface

(76) Inventor: Chia-Yuan Pang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/105,180

(22) Filed: Mar. 25, 2002

(30) Foreign Application Priority Data
Oct. 19, 2001 (TW) 90125965

(51) Int. Cl. G06F 3/00

(52) U.S. Cl. 710/38

(57) ABSTRACT

A system to select from among a plurality of devices to host a large-capacity storage interface. The system includes a first interface connector, a second interface connector, and an interface-transforming chip. The first interface connector is coupled to a first BUS cable to access first exterior data. The second interface connector is coupled to a second BUS cable and an interior BUS cable of the large-capacity storage interface to access second exterior data. The interface-transforming chip detects a control signal input to the second interface connector, then selects one of the first interface connector or the second interface connector to host the large-capacity storage interface according to the voltage level of the control signal.

### BACKGROUND OF THE INVENTION

1. Field of the Invention

The present invention relates in general to a method and a system to select from among a plurality of devices to host a large-capacity storage interface. In particular, the present invention relates to the selection from among a plurality of devices to host a large-capacity storage interface automatically according to the voltage level of a received control signal.

2. Description of the Related Art

Conventional large-capacity storing devices, such as hard disk, CD-ROM, CD-R, CD-RW, DVD-ROM, DVD-RAM, DVD-R, DVD−RW and DVD+RW, etc, are connected to hosts to transmit data through an interface such as USB, IDE, IEEE 1394, Serial ATA and SCSI. However, not each type of transmission interface of the large-capacity storing device is matched to the host. Therefore, conventional large-capacity storing devices have to comprise several types of transmission interfaces to satisfy all the interfaces of a host.

FIG. 1 is an architecture block diagram of a conventional large-capacity storage interface. The conventional large-capacity storage interface comprises a first interface connector 1a, a second interface connector 2a, an interface-transforming chip 3a, and a manual interface selector 4a. The first interface connector 1a and the second interface connector 2a are connected to a BUS cable respectively to access exterior data. In addition, the second interface connector 2a is connected to an interior BUS cable 5a of the large-capacity storage interface. The interface-transforming chip 3a is coupled to the first interface connector 1a and the interior BUS cable 5a of the large-capacity storage interface, and transforms the first interface connector 1a to a type of transmission interface the same as the second interface connector 2a. In addition, the manual interface selector 4a selects one of the first interface connector 1a or the second interface connector 2a to host the large-capacity storage interface by tri-state control.

Moreover, the interior BUS cable 5a is connected between the interface-controlling chip and peripheral circuits 6a, which comprises a first controlling BUS cable 51a, a second controlling BUS cable 52a, an address BUS cable 53a and a data BUS cable 54a. The connection between the interior BUS cable 5a and the interface-transforming chip 3a is controlled by the manual interface selector 4a to electrically open and close.

The possible combinations of the first interface connector 1a and the second interface connector 2a are:

(1) The first interface connector 1a is USB, and the second interface connector 2a is IDE.

(2) The first interface connector 1a is IEEE 1394, and the second interface connector 2a is IDE.

(3) The first interface connector 1a is Serial ATA, and the second interface connector 2a is IDE.

(4) The first interface connector 1a is USB, and the second interface connector 2a is SCSI.

(5) The first interface connector 1a is IEEE 1394, and the second interface connector 2a is SCSI.

(6) The first interface connector 1a is Serial ATA, and the second interface connector 2a is SCSI.

The possible transformation combinations of the interface-transforming chip 3a are:

(1) USB is transformed to IDE.

(2) IEEE 1394 is transformed to IDE.

(3) Serial ATA is transformed to IDE.

(4) USB is transformed to SCSI.

(5) IEEE 1394 is transformed to SCSI.

(6) Serial ATA is transformed to SCSI.

Therefore, when a user wants to use the second interface connector 2a, the second interface connector 2a is connected to the interface-controlling chip and peripheral circuits 6a, and the second interface connector 2a is selected by the manual interface selector 4a. Therefore, the interface-transforming chip 3a transforms the BUS across the interface-transforming chip 3a to high impedance to avoid the signal of the second interface connector 2a interfering with the first interface connector 1a. In addition, when the user wants to use the first interface connector 1a, the first interface connector 1a is connected to the interface-transforming chip 3a and the second interface connector 2a is disconnected from the BUS, and the first interface connector 1a is selected by the manual interface selector 4a. Therefore, the interface-transforming chip 3a transforms the BUS across the interface-transforming chip 3a to low impedance to avoid the signal of the first interface connector 1a interfering with the second interface connector 2a.

However, when the first interface connector 1a and the second interface connector 2a are connected to the BUS cable at the same time, if the second interface connector 2a is selected by the manual interface selector 4a, the second interface connector 2a performs normally. But the first interface connector 1a and the second interface connector 2a interfere with each other when the first interface connector 1a is selected by the manual interface selector 4a and the large-capacity storage interface may be broken.

### SUMMARY OF THE INVENTION

The object of the present invention is to provide a method and a system to select from among a plurality of devices to host a large-capacity storage interface automatically without using a manual interface selector.

To achieve the above-mentioned object, the present invention provides a system which includes a first interface connector, a second interface connector, and an interface-transforming chip. The first interface connector is coupled to a first BUS cable to access first exterior data. The second interface connector is coupled to a second BUS cable and an interior BUS cable of the large-capacity storage interface to access second exterior data. The interface-transforming chip detects a control signal input to the second interface connector, then selects one of the first interface connector or the second interface connector to host the large-capacity storage interface according to the voltage level of the control signal.

Moreover, the present invention provides a method, which selects a plurality of device to host a large-capacity storage interface to select one of the first interface connector or the second interface connector to host the large-capacity storage interface. The method comprises the following steps: the voltage level of a control signal input to the second interface connector is detected by the interface-transforming chip. If the voltage level of the control signal is a first voltage level, the large-capacity storage interface is hosted by the first interface connector, and if the voltage level of the control signal is a second voltage level, the large-capacity storage interface is hosted by the second interface connector.

### BRIEF DESCRIPTION OF THE DRAWINGS

The present invention will be come more fully understood from the detailed description given hereinbelow and the accompanying drawings, given by way of illustration only and thus not intended to be limitative of the present invention.

FIG. 1 is an architecture block diagram of a conventional large-capacity storage interface.

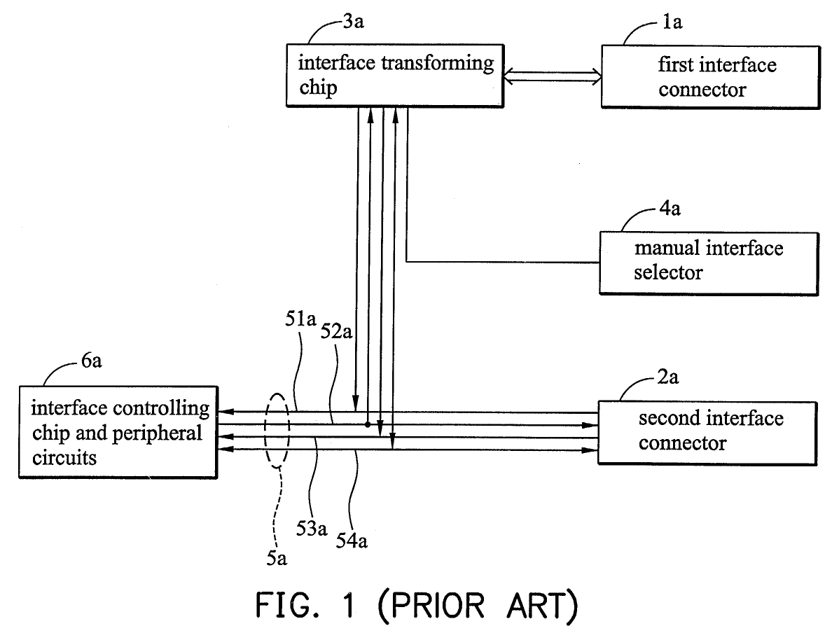

FIG. 2 is an architecture block diagram of the large-capacity storage interface according to the present invention.

### DETAILED DESCRIPTION OF THE PREFERRED EMBODIMENT

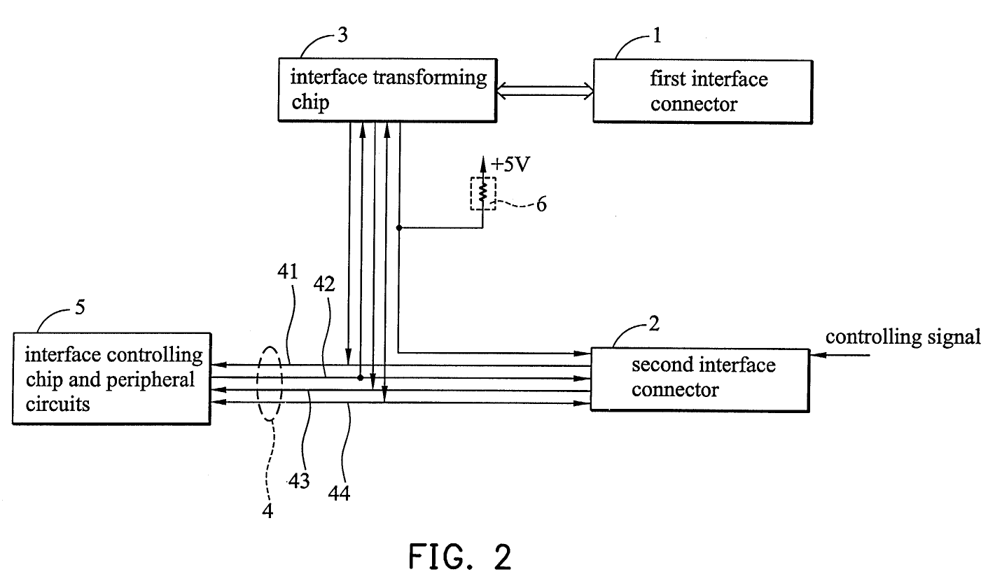

FIG. 2 is an architecture block diagram of the large-capacity storage interface according to the present invention.

The large-capacity storage interface according to the present invention comprises a first interface connector 1, a second interface connector 2, and an interface-transforming chip 3. The first interface connector 1 and the second interface connector 2 are connected to a BUS cable (not shown) respectively to access exterior data. In addition, the second interface connector 2 is connected to an interior BUS cable 4 of the large-capacity storage interface.

The interior BUS cable 4 is connected between the interface-controlling chip and peripheral circuits 5, which comprises a first controlling BUS cable 41, a second controlling BUS cable 42, an address BUS cable 43 and a data BUS cable 44. There is a control signal input to the second interface connector 2, and the connection between the interior BUS cable 4 and the interface-transforming chip 3 is controlled according to the control signal by tri-state to turn on (low impedance) or turn off (high impedance). The interface-transforming chip 3 selects one of the first interface connector 1 and the second interface connector 2 to host the interface-controlling chip and peripheral circuits 5.

The large-capacity storing devices may be a hard disk, a CD-ROM, a CD-R, a CD-RW, a DVD-ROM, a DVD-RAM, a DVD-R, a DVD−RW or a DVD+RW. The control signal is input to a GND or RESERVE pin of the second interface connector 2, and a resistor 6 connecting to a power source is connected to the interface-transforming chip 3.

The method according to the present invention to select one of the first interface connector or the second interface connector to host the large-capacity storage interface is described. Here, the voltage level of the control signal input to the second interface connector 2 is detected by the interface-transforming chip 3. If the voltage level of the control signal is high, the first controlling BUS cable 41, a second controlling BUS cable 42, an address BUS cable 43 and a data BUS cable 44 is hosted by the interface-transforming chip 3. At this time, the BUS 4 across the interface-transforming chip 3 is turned on, and the large-capacity storage interface is hosted by the first interface connector 1. If the voltage level of the control signal is low, the first controlling BUS cable 41, a second controlling BUS cable 42, an address BUS cable 43 and a data BUS cable 44 is not hosted by the interface-transforming chip 3. At this time, the BUS 4 across the interface-transforming chip 3 is turned off (high impedance), and the large-capacity storage interface is hosted by the second interface connector 2.

Therefore, the data stored in the large-capacity storage interface is accessed through the first interface connector 1 when there is only the first interface connector 1 connected to the BUS cable. At this time, the control signal is high, and the large-capacity storage interface is hosted by the first interface connector 1. On the contrary, the data stored in the large-capacity storage interface is accessed through the second interface connector 2 when there is only the second interface connector 2 connected to the BUS cable. At this time, the control signal is low, and the large-capacity storage interface is hosted by the second interface connector 2.

Moreover, if the first interface connector 1 and the second interface connector 2 are connected to the BUS cable, the data stored in the large-capacity storage interface is accessed through the second interface connector 2 because the control signal is low to avoid the data interfering with the interface-transforming chip 3.

Accordingly, the large-capacity storage interface of the present invention has the following advantages:

(1) The interface is selected automatically according to the voltage level of the control signal.

(2) The large-capacity storage interface is not damaged when the USB cable is connected to different types of interfaces.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for selecting from among a plurality of devices to host a large-capacity storage interface having a first interface connector, a second interface connector, and an interface-transforming chip to select one of the first interface connector or the second interface connector to host the large-capacity storage interface, the method comprising the following steps:
detecting the voltage level of a control signal input to the second interface connector by the interface-transforming chip; and
when the voltage level of the control signal is a first voltage level, hosting of the large-capacity storage interface by the first interface connector, and when the voltage level of the control signal is a second voltage level, hosting of the large-capacity storage interface by the second interface connector.

2. The method for selecting from among a plurality of devices to host a large-capacity storage interface as claimed in claim 1, wherein the first voltage level is high voltage level and the second voltage level is low voltage level.

3. The method for selecting from among a plurality of devices to host a large-capacity storage interface as claimed in claim 1, wherein the first voltage level is low voltage level and the second voltage level is high voltage level.

4. A system for selecting from among a plurality of devices to host a large-capacity storage interface, comprising:
a first interface connector coupled to a first BUS cable for accessing first exterior data;
a second interface connector coupled to a second BUS cable and an interior BUS cable of the large-capacity storage interface for accessing second exterior data; and
an interface-transforming chip coupled to the first interface connector and the interior BUS cable of the large-capacity storage interface for detecting a control signal input to the second interface connector and selecting one of the first interface connector or the second interface connector to host the large-capacity storage interface according to the voltage level of the control signal.

5. The system for selecting from among a plurality of devices to host a large-capacity storage interface as claimed in claim 4, wherein the large-capacity storage interface is a hard disk, a CD-ROM, a CD-R, a CD-RW, a DVD-ROM, a DVD-RAM, a DVD-R, a DVD−RW or a DVD+RW.

6. The system for selecting from among a plurality o f devices to host a large-capacity storage interface as claimed in claim 4, wherein the large-capacity storage interface is USB, IDE, IEEE 1394, Serial ATA or SCSI.

7. The system for selecting from among a plurality of devices to host a large-capacity storage interface as claimed in claim 4, wherein the control signal is input to a GND or RESERVE pin of the second interface connector, and a resistor coupling to a power source is coupled to the interface-transforming chip.

8. The system for selecting from among a plurality of devices to host a large-capacity storage interface as claimed in claim 4, wherein the interior BUS cable comprises a control BUS cable, an address BUS cable, and a data BUS cable, which are coupled to an interface-controlling chip and peripheral circuits.
